(19) United States
(12) Patent Application Publication
(10) Pub. No.: US 2005/0134615 A1
(43) Pub. Date: Jun. 23, 2005

(54) Method and apparatus for driving plasma display panel

(75) Inventor: Jun Hak Lee, Suwon-si (KR)

Correspondence Address: FLESHNER & KIM, LLP, P.O. BOX 221200, CHANTILLY, VA, 20153, US

(73) Assignee: LG Electronics Inc.

(21) Appl. No.: 11/005,037

(22) Filed: Dec. 7, 2004

(30) Foreign Application Priority Data
Dec. 8, 2003 (KR) 10-2003-0088672

(51) Int. Cl. G09G 3/28; G09G 5/02

(52) U.S. Cl. 345/694; 345/596; 345/60

(57) ABSTRACT

Disclosed herein are an apparatus and method for driving a plasma display panel in which dithering noise can be minimized. According to the present invention, the apparatus for driving the plasma display panel includes a red dithering mask pattern in which a dithering pattern of red sub-pixels among sub-pixels is stored, a green dithering mask pattern in which a dithering pattern of green sub-pixels among the sub-pixels is stored, and a blue dithering mask pattern in which a dithering pattern of blue sub-pixels among the sub-pixels is stored, wherein the red dithering mask pattern, the green dithering mask pattern and the blue dithering mask pattern are set to be different from one another. Therefore, concentration of light can be prevented and dithering noise can be thus minimized.

This Nonprovisional application claims priority under 35 U.S.C. §119(a) on Patent Application No. 10-2003-0088672 filed in Korea on Dec. 8, 2003, the entire contents of which are hereby incorporated by reference.

### BACKGROUND OF THE INVENTION

1. Field of the Invention

The present invention relates to an apparatus and method for driving a plasma display panel, and more particularly, to an apparatus and method for driving a plasma display panel in which dithering noise can be minimized.

2. Description of the Background Art

Recently, a plasma display panel (hereinafter, referred to as PDP ), which can be easily fabricated as a large-scale panel, has attracted public attention as a flat panel display device. The PDP is adapted to display an image by controlling a gas discharge period of each of pixels according to digital video data. A representative PDP is a PDP, which has three electrodes and is driven with an AC voltage, as shown in FIG. 1.

A discharge cell of an AC type PDP shown in FIG. 1 includes a pair of sustain electrodes 12A, 12B formed on the bottom surface of an upper substrate 10, and a data electrode 20 formed on the top surface of a lower substrate 18.

Each of the pair of the sustain electrodes 12A, 12B has a dual layer structure of a transparent electrode and a metal electrode. This pair of the sustain electrodes 12A, 12B includes a scan electrode 12A which receives a scan signal for an address discharge and a sustain signal for a sustain discharge as an input, and a sustain electrode 12B which receives a sustain signal, while operating in turn with the scan electrode 12A. The data electrode 20 is formed to cross the pair of the sustain electrodes 12A, 12B, and receives a data signal for an address discharge.

An upper dielectric layer 14 and a protection film 16 are laminated on the upper substrate 10 on which the pair of the sustain electrodes 12A, 12B are formed. A lower dielectric layer 22 is formed on the lower substrate 18 on which the data electrode 20 is formed. The upper dielectric layer 14 and the lower dielectric layer 22 serve to accumulate electric charges generated upon discharging. The protection film 16 serves to prevent damage of the upper dielectric layer 14 due to sputtering of plasma particles upon discharging, and increase emission efficiency of secondary electrons. The dielectric layer 14 and the protection film 16 allow an external input driving voltage to be low.

Barrier ribs 24 are formed over the lower substrate 18 on which the lower dielectric layer 22 is formed. A phosphor layer 26 is formed on the lower dielectric layer 22 and the barrier ribs 24. The barrier ribs 24 serve to separate discharge spaces and prevent an ultraviolet ray generated by a gas discharge from leaking toward neighboring discharge spaces. The phosphor layer 26 is light-emitted by the ultraviolet ray generated in the gas discharge, thus producing red (R), green (G) and blue (B) visible rays. Furthermore, an inert gas for the gas discharge is inserted into the discharge spaces.

This discharge cell is selected according to an address discharge by the data electrode 20 and the scan electrode 12A. The selected discharge cell sustains a discharge thereof with a sustain discharge by the pair of the sustain electrodes 12A, 12B. Furthermore, the discharge cell emits the phosphor layer 26 with the ultraviolet ray generated in the sustain discharge, so that the phosphor layer 26 produces R, G and B visible rays. In this case, the discharge cell implements the gray scale necessary for displaying an image by controlling a sustain discharge period, i.e., the number of a sustain discharge according to video data. Moreover, a combination of three discharge cells on which the R, G and B phosphors 26 are coated, respectively, implements the colors of one pixel.

A representative method for driving this PDP is an ADS (Address and Display Separation) driving method in which the PDP is driven with it being divided into an address period and a display period, i.e., a sustain period. In the ADS driving method, one frame 1F is divided into a plurality of sub-fields SF1 to SF8 corresponding to respective bits of video data, as shown in FIG. 2. Each of the sub-fields SF1 to SF8 is subdivided into a reset period RPD for initializing a discharge cell, an address period APD for selecting a discharge cell, and a sustain period SPD for maintaining discharging of the selected discharge cell. In this time, a PDP implements a corresponding gray scale in such a manner that the sustain periods SPD are assigned with a different weight by the sub-fields SF1 to SF8, and the sustain periods SPD are then combined according to video data.

In this conventional PDP, in order to display an image of various gray scales, an error diffusion method, a dithering method and the like are employed.

The error diffusion method includes calculating quantization error data of digital video data using the Floyd-Steinberg error diffusion filter, etc., assigning the calculated error data with a different weight and diffusing them to neighboring pixels. In the error diffusion method, however, error diffusion coefficients (i.e., weight) for neighboring pixels are set to be constant. Therefore, there is a problem in that an error diffusion pattern is generated due to the constant error diffusion coefficients since the error diffusion coefficients are repeated every line and every frame.

The dithering method includes expanding the range of a display gray scale by additionally selecting discharge cells to be turned on by using a dither mask pattern having a plurality of frames, a plurality of lines and a plurality of columns corresponding to input data.

FIG. 3 shows conventional dither mask patterns. In FIG. 3, each of the dither mask patterns includes a plurality of frame patterns (for example, four frame patterns F1 to F4), which are provided corresponding to a variety of gray scales (0, 1, 2,). In this case, gray scale values corresponding to dither mask patterns can be set to be various. For explanation s convenience, only dither mask patterns corresponding to the gray scales of 0 to 2 are shown in FIG. 3.

Referring to FIG. 3, the dither mask patterns are set to be different from one another corresponding to various gray scales (0, 1, 2 . . . ). Moreover, the dither mask patterns can be set to be different from one another corresponding to frames, lines and pixels so that soft gray scales can be represented. That is, the position of the dither value “1” in each of the dither mask patterns is set to be different from one another corresponding to a frame, line and pixel. In this time, in the dither mask pattern, the dither value “0” is selected as an off-cell regardless of input data, and the dither value “1” is selected as an on-cell or an off-cell corresponding to input data.

An operating procedure will now be described in detail with reference to FIG. 4. In FIG. 4, numerals 0, 1 and 2 indicate gray scale values that are inputted to sub-pixel cells, respectively, corresponding to the first frame 1F. In reality, a variety of gray scale values corresponding to input gray scale values are inputted to a dithering unit that carries out dithering. It is assumed in FIG. 4 that only the gray scales 0 to 2 are inputted to the dithering unit for the convenience of the explanation. Data 1 is inputted to a sub-pixel at the position of 1 column-1 row (1-1).

In this time, since the sub-pixel has the first frame of the dither mask pattern and data of 1 and the position of 1 column-1 row (1-1) has the dither value “1”, it is selected as an on-cell. Next, since data of 0 is inputted to 2 column-1 row (2-1) and 3 column-1 row (3-1), corresponding sub-pixels are selected as an off-cell corresponding to the first frame, data 0 and respective positions. Data of 2 is inputted to 4 column-1 row (4-1). In this time, since a sub-pixel has the first frame of the dither mask pattern and data 2 and the position of 4 column-1 row (4-1) has the dither value “0”, it is selected as an off-cell. Practically, the conventional dithering unit selects sub-pixel cells to be turned on by repeating this method.

Meanwhile, in order to perform dithering in a sub-pixel unit, dither mask patterns are respectively provided corresponding to red (R) sub-pixels, green (G) sub-pixels and blue (B) sub-pixels, as shown in FIG. 5. In this time, the dither mask pattern of the red (R) sub-pixels, the dither mask pattern of the green (G) sub-pixels and the dither mask pattern of the blue (B) sub-pixels are set to be the same. In other words, the position of the dither value “1” in each of the dither mask patterns is set to be the same.

As such, if the dither mask patterns of the red (R), green (G) and the blue (B) sub-pixels are set to be the same, however, light is locally concentrated. This light acts as noise. In other words, in each of the dither mask patterns shown in FIG. 5, if the position of the dither value “1” is indicated in the sub-pixels, the dither values “1” are concentrated and arranged, as shown in FIG. 6.

In more detail, if the dither values 1 of the four frames 1F to 4F are indicated corresponding to the sub-pixels in FIG. 5, the dither values “1” are concentrated to form a specific pattern, as shown in FIG. 6. In this state, if an image is displayed, a locally concentrated light is generated, which acts as noise. Resultantly, This light makes the eye of a viewer unpleasant.

### SUMMARY OF THE INVENTION

Accordingly, the present invention has been made in view of the above problems, and it is an object of the present invention to provide an apparatus and method for driving a plasma display panel in which dithering noise can be minimized.

To achieve the above object, according to an embodiment of the present invention, there is provided an apparatus for driving a plasma display panel, including: a red dithering mask pattern in which a dithering pattern of red sub-pixels among sub-pixels is stored, a green dithering mask pattern in which a dithering pattern of green sub-pixels among the sub-pixels is stored, and a blue dithering mask pattern in which a dithering pattern of blue sub-pixels among the sub-pixels is stored, wherein the red dithering mask pattern, the green dithering mask pattern and the blue dithering mask pattern are set to be different from one another.

According to an embodiment of the present invention, there is provided a method of driving a plasma display panel, including the steps of: storing a first dithering pattern of red sub-pixels among sub-pixels, storing a second dithering pattern of green sub-pixels among the sub-pixels, and storing a third dithering pattern of blue sub-pixels among the sub-pixels, wherein the first dithering pattern, the second dithering pattern and the third dithering pattern are set to be different from one another.

According to the present invention, brightness, efficiency and the contrast ratio are improved and high-speed driving is accomplished.

### BRIEF DESCRIPTION OF THE DRAWINGS

Further objects and advantages of the invention can be more fully understood from the following detailed description taken in conjunction with the accompanying drawings in which:

FIG. 1 is a perspective view illustrating the construction of the discharge cell of the three-electrode AC surface discharge type PDP;

FIG. 2 is a view illustrating one frame of the PDP;

FIG. 3 shows conventional dither mask patterns;

FIG. 4 illustrates cells which are turned on by the dither mask patterns of FIG. 3 corresponding to external input gray scale values;

FIG. 5 shows dither mask patterns of a sub-pixel unit in a prior art;

FIG. 6 is a view illustrating that the dither values of 1 are indicated in the sub-pixels in the dither mask patterns shown in FIG. 5;

FIG. 7 shows dither mask patterns of a sub-pixel unit according to an embodiment of the present invention; and

FIG. 8 is a view illustrating that the dither values of 1 are indicated in the sub-pixels in the dither mask patterns shown in FIG. 7.

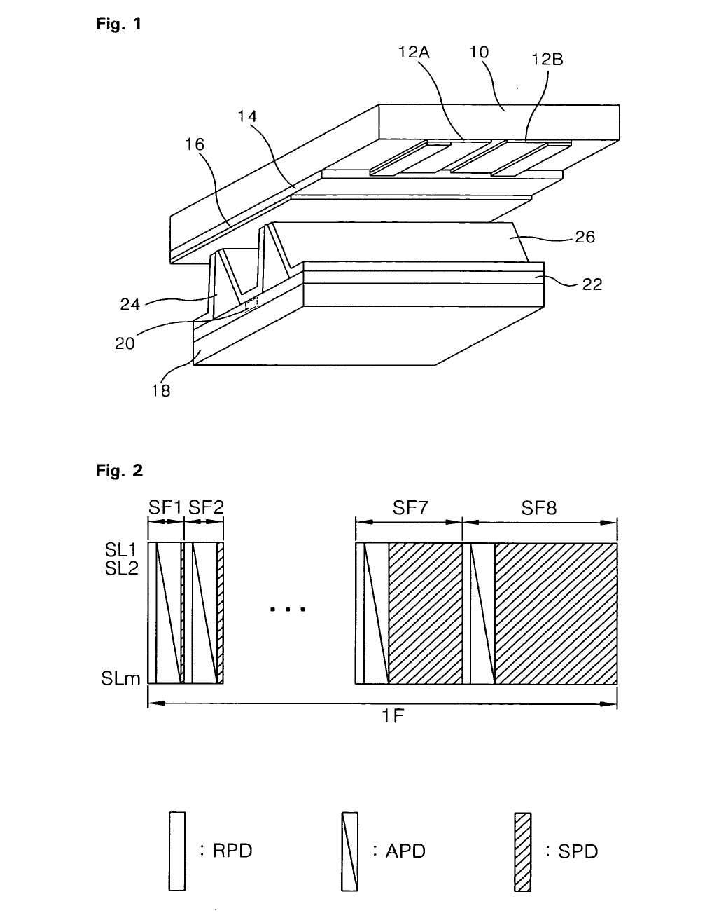

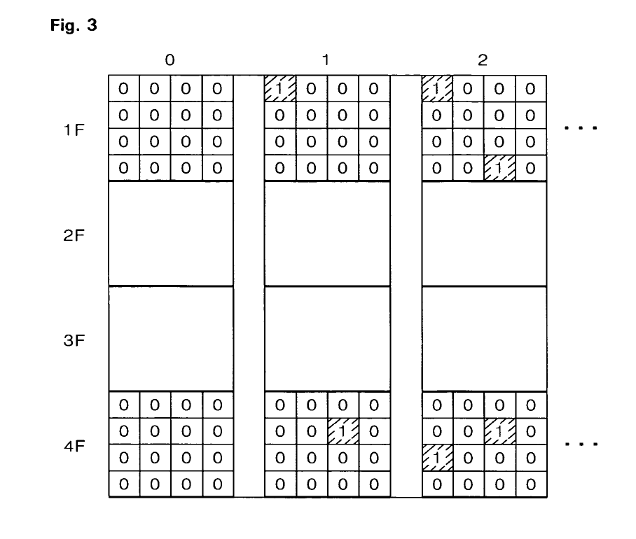

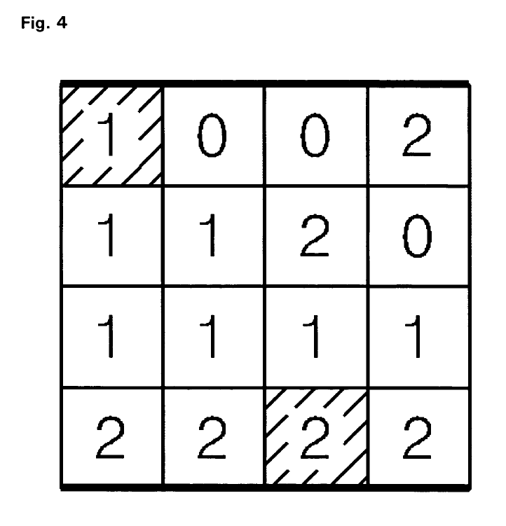

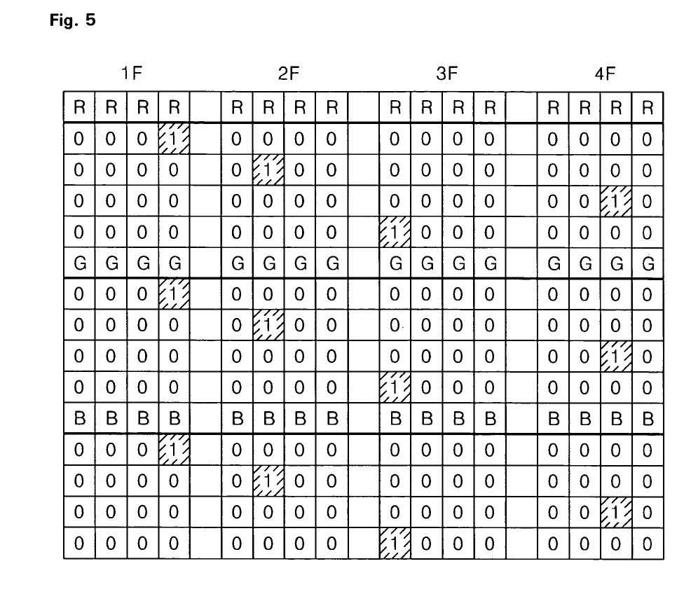

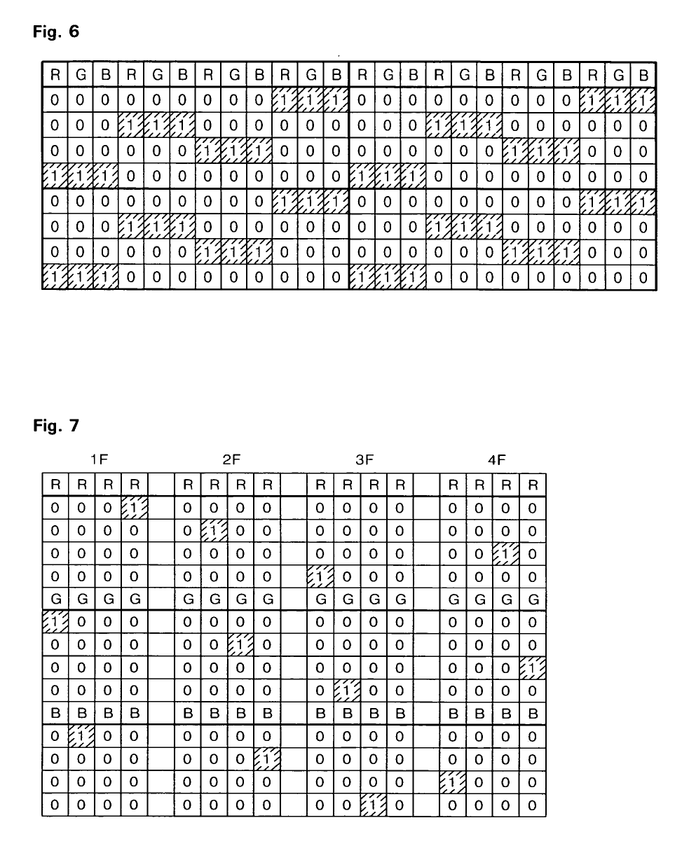

### DETAILED DESCRIPTION OF PREFERRED EMBODIMENTS

Preferred embodiments of the present invention will be described in a more detailed manner with reference to the drawings.

To achieve the above object, according to an embodiment of the present invention, there is provided an apparatus for driving a plasma display panel, including: a red dithering mask pattern in which a dithering pattern of red sub-pixels among sub-pixels is stored, a green dithering mask pattern in which a dithering pattern of green sub-pixels among the sub-pixels is stored, and a blue dithering mask pattern in which a dithering pattern of blue sub-pixels among the sub-pixels is stored, wherein the red dithering mask pattern, the green dithering mask pattern and the blue dithering mask pattern are set to be different from one another.

The positions of dither values 1, which are included in each of the red dithering mask pattern, the green dithering mask pattern and the blue dithering mask pattern are set to be different from one another.

The green dithering mask pattern is set by shifting the dither values 1 included in the red dithering mask pattern by one bit or more to the left or right.

The green dithering mask pattern is set by shifting the dither values 1 included in the red dithering mask pattern by one bit to the right.

The green dithering mask pattern is set by shifting the dither values 1 included in the red dithering mask pattern by one bit to the left.

The blue dithering mask pattern is set by shifting the dither values 1 included in the green dithering mask pattern 1 bit or more to the left or right.

The blue dithering mask pattern is set by shifting the dither values 1 included in the green dithering mask pattern by one bit to the right.

The blue dithering mask pattern is set by shifting the dither values 1 included in the green dithering mask pattern by one bit to the left.

According to an embodiment of the present invention, there is provided a method of driving a plasma display panel, including the steps of: storing a first dithering pattern of red sub-pixels among sub-pixels, storing a second dithering pattern of green sub-pixels among the sub-pixels, and storing a third dithering pattern of blue sub-pixels among the sub-pixels, wherein the first dithering pattern, the second dithering pattern and the third dithering pattern are set to be different from one another.

The second dithering pattern is found by shifting the first dithering pattern by one bit or more to the left or right.

The third dithering pattern is found by shifting the second dithering pattern by one bit or more to the left or right.

FIG. 7 shows dither mask patterns of a sub-pixel unit according to an embodiment of the present invention.

Referring to FIG. 7, the dither mask patterns of the present embodiment are provided corresponding to red (R) sub-pixels, green (G) sub-pixels and blue (B) sub-pixels, respectively. In this time, the dither mask pattern of the red (R) sub-pixels, the dither mask pattern of the green (G) sub-pixels and the dither mask pattern of the blue (B) sub-pixels are set to be different from one another.

This will be below described in detail. The dither mask pattern of the green (G) sub-pixel is set by shifting the dither value 1 of the dither mask pattern of the red (R) sub-pixel by one bit or more to the left or right. For example, as shown in FIG. 7, the dither mask pattern of the green (G) sub-pixel can be set by shifting the dither value 1 of the dither mask pattern of the red (R) sub-pixel by one bit to the right. (Actually, the dither mask pattern of the green (G) sub-pixel can be set by shifting the dither value 1 of the dither mask pattern of the red (R) sub-pixel by one bit to the left.)

The dither mask pattern of the blue (B) sub-pixel is set by shifting the dither value 1 of the dither mask pattern of the green (G) sub-pixel by one bit or more to the left or right. For example, as shown in FIG. 7, the dither mask pattern of the blue (B) sub-pixel can be set by shifting the dither value 1 of the dither mask pattern of the green (G) sub-pixel by one bit to the right. (In reality, the dither mask pattern of the blue (B) sub-pixel can be set by shifting the dither value 1 of the dither mask pattern of the green (G) sub-pixel by one bit to the left.)

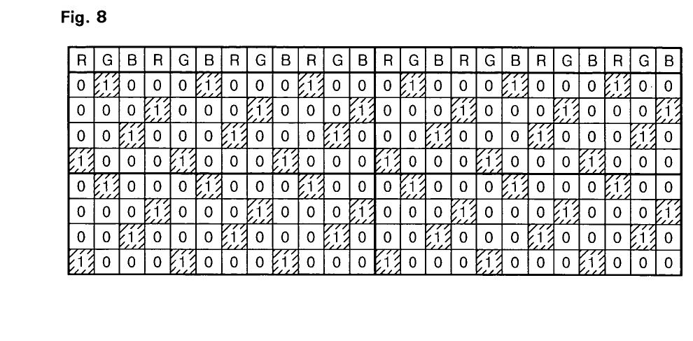

As such, if the positions of the dither values 1 are set to be different from one another in the dither mask pattern of each of the red (R), green (G) and blue (B) sub-pixels, dithering noise generating due to concentrated light can be prevented. In other words, in this case, if the positions of 1 are indicated in the sub-pixels in each of the dither mask patterns shown in FIG. 7, the dither values 1 are distributed, as shown in FIG. 8.

This will be described in detail. If the dither values 1 of the four frames 1F to 4F are displayed corresponding to the sub-pixels in FIG. 7, the dither values “1” are distributed variously, as shown in FIG. 8. Accordingly, the present invention is advantageous in that it can prevent concentration of light due to dithering and thus minimize dithering noise.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

1. An apparatus for driving a plasma display panel in which dithering is performed in a sub-pixel unit, comprising:
a red dithering mask pattern in which a dithering pattern of red sub-pixels among sub-pixels is stored;
a green dithering mask pattern in which a dithering pattern of green sub-pixels among the sub-pixels is stored; and
a blue dithering mask pattern in which a dithering pattern of blue sub-pixels among the sub-pixels is stored,
wherein the red dithering mask pattern, the green dithering mask pattern and the blue dithering mask pattern are set to be different from one another.

2. The apparatus as claimed in claim 1, wherein the positions of dither values 1, which are included in each of the red dithering mask pattern, the green dithering mask pattern and the blue dithering mask pattern are set to be different from one another.

3. The apparatus as claimed in claim 2, wherein the green dithering mask pattern is set by shifting the dither values 1 included in the red dithering mask pattern by one bit or more to the left or right.

4. The apparatus as claimed in claim 3, wherein the green dithering mask pattern is set by shifting the dither values 1 included in the red dithering mask pattern by one bit to the right.

5. The apparatus as claimed in claim 3, wherein the green dithering mask pattern is set by shifting the dither values 1 included in the red dithering mask pattern by one bit to the left.

6. The apparatus as claimed in claim 2, wherein the blue dithering mask pattern is set by shifting the dither values 1 included in the green dithering mask pattern by one bit or more to the left or right.

7. The apparatus as claimed in claim 6, wherein the blue dithering mask pattern is set by shifting the dither values 1 included in the green dithering mask pattern by one bit to the right.

8. The apparatus as claimed in claim 6, wherein the blue dithering mask pattern is set by shifting the dither values 1 included in the green dithering mask pattern by one bit to the left.

9. A method of driving a plasma display panel in which dithering is performed in a sub-pixel unit, comprising the steps of:
(a) storing a first dithering pattern of red sub-pixels among sub-pixels;
(b) storing a second dithering pattern of green sub-pixels among the sub-pixels; and
(c) storing a third dithering pattern of blue sub-pixels among the sub-pixels,
wherein the first dithering pattern, the second dithering pattern and the third dithering pattern are set to be different from one another.

10. The method as claimed in claim 9, wherein the second dithering pattern is found by shifting the first dithering pattern by one bit or more to the left or right.

11. The method as claimed in claim 9, wherein the third dithering pattern is found by shifting the second dithering pattern by 1 bit or more to the left or right.
